(19) United States
(12) Patent Application Publication
(10) Pub. No.: US 2026/0292149 A1
(43) Pub. Date: Sep. 24, 2026

(54) Methods and Apparatus for Intra Mode Fusion in an Image and Video Coding System

(71) Applicant: MEDIATEK INC., Hsinchu City (TW)

(72) Inventor: Shih-Ta HSIANG, Hsinchu City (TW)

(21) Appl. No.: 19/472,649

(22) PCT Filed: Apr. 23, 2024
(86) PCT No.: PCT/CN2024/089363

§ 371 Date: Oct. 4, 2025

Related U.S. Application Data
(60) Provisional application No. 63/500,309, filed on May 5, 2023.

(51) Int. Cl. H04N 19/11; H04N 19/105; H04N 19/176; H04N 19/593; H04N 19/70

(52) U.S. Cl. CPC H04N 19/11; H04N 19/105; H04N 19/176; H04N 19/593; H04N 19/70

(57) ABSTRACT

A method and apparatus for video coding using a multi-line fused predictor are disclosed. According to this method, a reference region comprising multiple reference lines is determined. A first selected intra mode is determined from a set of intra mode candidates based on costs associated with the set of intra mode candidates. A first multi-line predictor is derived as a weighted sum of two or more first-selected-intra-mode predictors and each of said two or more first-selected-intra-mode predictors is derived according to the first selected intra mode based on one respective reference line in the reference region, and at least two first-selected-intra-mode predictors use different reference lines. A fused predictor comprising the first multi-line predictor and at least another intra predictor is generated. The current block is encoded or decoded using information comprising the fused predictor.

### CROSS REFERENCE TO RELATED APPLICATIONS

The present invention is a non-Provisional Application of and claims priority to U.S. Provisional Patent Application No. 63/500,309, filed on May 5, 2023. The U.S. Provisional Patent Application is hereby incorporated by reference in its entirety.

### FIELD OF THE INVENTION

The present invention relates to video coding system. In particular, the present invention relates to generating a fused intra predictor based on multiple predictors comprising at least one multi-line fused predictor derived as a weighted sum of respective predictors using different reference lines for a selected intra mode.

### BACKGROUND

Versatile video coding (VVC) is the latest international video coding standard developed by the Joint Video Experts Team (JVET) of the ITU-T Video Coding Experts Group (VCEG) and the ISO/IEC Moving Picture Experts Group (MPEG). The standard has been published as an ISO standard: ISO/IEC 23090-3:2021, Information technology-Coded representation of immersive media-Part 3: Versatile video coding, published February 2021. VVC is developed based on its predecessor HEVC (High Efficiency Video Coding) by adding more coding tools to improve coding efficiency and also to handle various types of video sources including 3-dimensional (3D) video signals.

FIG. 1A illustrates an exemplary adaptive Inter/Intra video encoding system incorporating loop processing. For Intra Prediction 110, the prediction data is derived based on previously coded video data in the current picture. For Inter Prediction 112, Motion Estimation (ME) is performed at the encoder side and Motion Compensation (MC) is performed based on the result of ME to provide prediction data derived from other picture(s) and motion data. Switch 114 selects Intra Prediction 110 or Inter Prediction 112 and the selected prediction data is supplied to Adder 116 to form prediction errors, also called residues. The prediction error is then processed by Transform (T) 118 followed by Quantization (Q) 120. The transformed and quantized residues are then coded by Entropy Encoder 122 to be included in a video bitstream corresponding to the compressed video data. The bitstream associated with the transform coefficients is then packed with side information such as motion and coding modes associated with Intra prediction and Inter prediction, and other information such as parameters associated with loop filters applied to underlying image area. The side information associated with Intra Prediction 110, Inter prediction 112 and in-loop filter 130, is provided to Entropy Encoder 122 as shown in FIG. 1A. When an Inter-prediction mode is used, a reference picture or pictures have to be reconstructed at the encoder end as well. Consequently, the transformed and quantized residues are processed by Inverse Quantization (IQ) 124 and Inverse Transformation (IT) 126 to recover the residues. The residues are then added back to prediction data 136 at Reconstruction (REC) 128 to reconstruct video data. The reconstructed video data may be stored in Reference Picture Buffer 134 and used for prediction of other frames.

As shown in FIG. 1A, incoming video data undergoes a series of processing in the encoding system. The reconstructed video data from REC 128 may be subject to various impairments due to a series of processing. Accordingly, in-loop filter 130 is often applied to the reconstructed video data before the reconstructed video data are stored in the Reference Picture Buffer 134 in order to improve video quality. For example, deblocking filter (DF), Sample Adaptive Offset (SAO) and Adaptive Loop Filter (ALF) may be used. The loop filter information may need to be incorporated in the bitstream so that a decoder can properly recover the required information. Therefore, loop filter information is also provided to Entropy Encoder 122 for incorporation into the bitstream. In FIG. 1A, Loop filter 130 is applied to the reconstructed video before the reconstructed samples are stored in the reference picture buffer 134. The system in FIG. 1A is intended to illustrate an exemplary structure of a typical video encoder. It may correspond to the High Efficiency Video Coding (HEVC) system, VP8, VP9, H.264 or VVC.

The decoder, as shown in FIG. 1B, can use similar or portion of the same functional blocks as the encoder except for Transform 118 and Quantization 120 since the decoder only needs Inverse Quantization 124 and Inverse Transform 126. Instead of Entropy Encoder 122, the decoder uses an Entropy Decoder 140 to decode the video bitstream into quantized transform coefficients and needed coding information (e.g. ILPF information, Intra prediction information and Inter prediction information). The Intra prediction 150 at the decoder side does not need to perform the mode search. Instead, the decoder only needs to generate Intra prediction according to Intra prediction information received from the Entropy Decoder 140. Furthermore, for Inter prediction, the decoder only needs to perform motion compensation (MC 152) according to Inter prediction information received from the Entropy Decoder 140 without the need for motion estimation.

In VVC, the Sequence Parameter Set (SPS) and the Picture Parameter Set (PPS) contain high-level syntax elements that apply to entire coded video sequences and pictures, respectively. The Picture Header (PH) and Slice Header (SH) contain high-level syntax elements that apply to a current coded picture and a current coded slice, respectively.

In VVC, a coded picture is partitioned into non-overlapped square block regions represented by the associated coding tree units (CTUs). A coded picture can be represented by a collection of slices, each comprising an integer number of CTUs. The individual CTUs in a slice are processed in raster-scan order. A bi-predictive (B) slice may be decoded using intra prediction or inter prediction with at most two motion vectors and reference indices to predict the sample values of each block. A predictive (P) slice is decoded using intra prediction or inter prediction with at most one motion vector and reference index to predict the sample values of each block. An intra (I) slice is decoded using intra prediction only.

In VVC, each CTU can be partitioned into one or multiple non-overlapped coding units (CUs) using a Quaternary Tree (QT) with nested Multi-Type-Tree (MTT) structure. The partitioning information is signalled by a coding tree syntax structure, where each CTU is treated as the root of a coding tree. The CTUs may be first partitioned by the quaternary tree (a.k.a. quadtree) structure, as shown in FIG. 2A. Then the quaternary tree leaf nodes can be further partitioned by a MTT structure, as shown in FIGS. 2B-E. There are four splitting types in multi-type tree structure: vertical binary splitting (SPLIT_BT_VER), horizontal binary splitting (SPLIT_BT_HOR), vertical ternary splitting (SPLIT_TT_VER), and horizontal ternary splitting (SPLIT_TT_HOR). Each quadtree child node may be further split into smaller coding tree nodes using any one of five split types in FIG. 2. However, each multi-type-tree child node is only allowed to be further split by one of four MTT split types. The coding tree leaf nodes correspond to the coding units (CUs). FIG. 3 provides an example of a CTU recursively partitioned by QT with the nested MTT, where the bold block edges represent quadtree partitioning and the remaining edges represent multi-type tree partitioning.

Each CU contains one or more Prediction Units (PUs). The prediction unit, together with the associated CU syntax, works as a basic unit for signalling the predictor information. The specified prediction process is employed to predict the values of the associated pixel samples inside the PU. Each CU may contain one or more transform units (TUs) for representing the prediction residual blocks. A transform unit (TU) is comprised of one transform block (TB) of luma samples and two corresponding transform blocks of chroma samples. Each TB corresponds to one residual block of samples from one colour component. An integer transform is applied to a transform block. The level values of quantized coefficients together with other side information are entropy coded in the bitstream. The terms coding tree block (CTB), coding block (CB), prediction block (PB), and transform block (TB) are defined to specify the 2-D sample array of one colour component associated with CTU, CU, PU, and TU, respectively. Thus, a CTU consists of one luma CTB, two chroma CTBs, and associated syntax elements. A similar relationship is valid for CU, PU, and TU.

Joint Video Expert Team (JVET) of ITU-T SG16 WP3 and ISO/IEC JTC1/SC29/WG11 are currently in the process of exploring the next-generation video coding standard. Some promising new coding tools have been adopted into Enhanced Compression Model 8 (ECM 8) (M. Coban, F. Le Léannec, R.-L. Liao, K. Naser, J. Ström, L. Zhang “Algorithm description of Enhanced Compression Model 8 (ECM 8),” Joint Video Expert Team (JVET) of ITU-T SG 16 WP 3 and ISO/IEC JTC I/SC 29, Doc. JVET-AC2025, 29th Meeting, by teleconference, 11-20 Jan. 2023) to further improve VVC.

In ECM 8.0, a template-based intra mode derivation (TIMD) coding tool is utilized for intra coding a coding unit. A CU syntax flag is coded to indicate whether the TIMD tool is enabled for coding a current CU or not. When the TIMD mode is enabled for a current CU, for each intra prediction mode in the most probable mode (MPM) list, a template-matching cost based on the sum of absolute transformed differences (SATD) between the prediction and reconstruction samples of the template for the current CU is calculated, as illustrated in FIG. 4. The two intra prediction modes with the lowest SATD and the second lowest SATD are referred to as the primary TIMD intra prediction mode and the secondary TIMD intra prediction mode, respectively. When the template-matching costs costMode1 and costMode2 for primary TIMD intra prediction mode and the secondary TIMD intra prediction mode meets the condition costMode2>=2*costMode1, the final prediction signal for the current CU is set equal to the intra predictor corresponding to the primary intra prediction mode. Otherwise, the TIMD multi-mode fusion is used for the current CU and the final prediction signal P_{fusion} is set equal to a weighted sum of two intra predictors Pₘ₀ and Pₘ₁, corresponding to the primary intra prediction mode m0 and the second intra prediction mode m1, respectively, as follows:

$${P}_{fusion} = {w}_{0} * {P}_{m 0} + {w}_{1} * {P}_{m 1} \qquad ( 1 )$$

wherein w₀ and w₁ are fusion weights for predictors Pₘ₀ and Pₘ₁, respectively.

Template-based intra mode derivation (TIMD) mode implicitly derives the intra prediction mode of a CU using a neighbouring template at both the encoder and decoder, instead of signalling the intra prediction mode to the decoder. As shown in FIG. 4, the prediction samples of the template (412 and 414) for the current block 410 are generated using the reference samples (420 and 422) of the template for each candidate mode.

In the present invention, schemes for generating a fused intra predictor based on multiple predictors comprising at least one multi-line fused predictor derived as a weighted sum of respective predictors using different reference lines for a selected intra mode are disclosed.

### BRIEF SUMMARY OF THE INVENTION

A method and apparatus for video coding using a multi-line fused predictors are disclosed. According to this method, input data associated with a current block are received, wherein the input data comprises pixel data to be encoded at an encoder side or coded data associated with the current block to be decoded at a decoder side, and wherein the current block is coded in intra prediction. One or more templates for the current block are determined. A reference region for said one or more templates is determined, wherein the reference region comprises multiple reference lines. A first selected intra mode from a set of intra mode candidates is determined based on costs associated with the set of intra mode candidates, wherein a target cost for a target intra mode candidate is evaluated based on reconstructed signals and predicted signals in said one or more templates for the target intra mode candidate, and the predicted signals in said one or more templates for the target intra mode candidate are generated based on the reference region. A first multi-line predictor is derived as a weighted sum of two or more first-selected-intra-mode predictors, wherein each of said two or more first-selected-intra-mode predictors is derived according to the first selected intra mode based on one respective reference line in the reference region, and at least two first-selected-intra-mode predictors use different reference lines. A fused predictor comprising the first multi-line predictor and at least another intra predictor is generated. The current block is encoded or decoded using information comprising the fused predictor.

In one embodiment, said at least another intra predictor comprises a second multi-line predictor generated by determining a second selected intra mode from the set of intra mode candidates based on the costs associated with the set of intra mode candidates, and deriving the second multi-line predictor as a weighted sum of two or more second-selected-intra-mode predictors, wherein each of said two or more second-selected-intra-mode predictors is derived according to the second selected intra mode based on one respective reference line in the reference region, and at least two second-selected-intra-mode predictors use different reference lines.

In one embodiment, a set of weights for the weighted sum of two or more first-selected-intra-mode predictors is determined for the current block adaptively. In another embodiment, a set of weights for the weighted sum of two or more first-selected-intra-mode predictors is determined for the current block according to one or more pre-defined rules.

In one embodiment, one or more syntax elements to indicate values of a set of weights for the weighted sum of two or more first-selected-intra-mode predictors are signalled in a bitstream or parsed from the bitstream. In one embodiment, said one or more syntax elements are in one or more high-level syntax sets. In one embodiment, said one or more syntax sets comprise SPS (Sequence Parameter Set), PPS (Picture Parameter Set), PH (Picture Header), SH (Slice Header), or a combination thereof.

In one embodiment, one or more syntax elements are signalled in a bitstream or parsed from the bitstream for deriving values of a set of weights for the weighted sum of two or more first-selected-intra-mode predictors.

In one embodiment, said deriving the first multi-line predictor and said generating the fused predictor comprising the first multi-line predictor and said at least another intra predictor are disabled for the current block according to one or more pre-defined rules. In one embodiment, said deriving the first multi-line predictor and said generating the fused predictor comprising the first multi-line predictor and said at least another intra predictor are disabled for the current block if the current block is coded in one or more target prediction modes. In one embodiment, said one or more target prediction modes comprise DC prediction mode and Planar prediction mode.

In one embodiment, one or more high-level syntax sets are used to indicate whether said deriving the first multi-line predictor and said generating the fused predictor comprising the first multi-line predictor and said at least another intra predictor are enabled or disabled for a current video data unit. In one embodiment, said one or more high-level syntax sets comprise SPS (Sequence Parameter Set), PPS (Picture Parameter Set), PH (Picture Header), SH (Slice Header), or a combination thereof.

In one embodiment, a set of weights for the weighted sum of two or more first-selected-intra-mode predictors is determined implicitly. In one embodiment, the set of weights for the weighted sum of two or more first-selected-intra-mode predictors is determined according to block dimension, area size, QP, reference line index, prediction mode associated with the current block, or a combination thereof.

In one embodiment, a set of weights for the weighted sum of two or more first-selected-intra-mode predictors is determined implicitly when width, height, and/or size of the current block is greater than or less than one or more specified threshold values.

### BRIEF DESCRIPTION OF THE DRAWINGS

FIG. 1A illustrates an exemplary adaptive Inter/Intra video coding system incorporating loop processing.

FIG. 1B illustrates a corresponding decoder for the encoder in FIG. 1A.

FIG. 2A-FIG. 2E illustrates examples of a multi-type tree structure corresponding to quadtree splitting (FIG. 2A) vertical binary splitting (SPLIT_BT_VER, FIG. 2B), horizontal binary splitting (SPLIT_BT_HOR, FIG. 2C), vertical ternary splitting (SPLIT_TT_VER, FIG. 2D), and horizontal ternary splitting (SPLIT_TT_HOR, FIG. 2E).

FIG. 3 shows an example of a CTU divided into multiple CUs with a quadtree and nested multi-type tree coding block structure, where the bold block edges represent quadtree partitioning and the remaining edges represent multi-type tree partitioning.

FIG. 4 illustrates an example of template-based intra mode derivation (TIMD) mode, where TIMD implicitly derives the intra prediction mode of a CU using a neighbouring template at both the encoder and decoder.

FIG. 5 illustrates a flowchart of an exemplary video coding system that incorporates a multi-line fused predictor according to an embodiment of the present invention.

### DETAILED DESCRIPTION OF THE INVENTION

It will be readily understood that the components of the present invention, as generally described and illustrated in the figures herein, may be arranged and designed in a wide variety of different configurations. Thus, the following more detailed description of the embodiments of the systems and methods of the present invention, as represented in the figures, is not intended to limit the scope of the invention, as claimed, but is merely representative of selected embodiments of the invention. References throughout this specification to “one embodiment,” “an embodiment,” or similar language mean that a particular feature, structure, or characteristic described in connection with the embodiment may be included in at least one embodiment of the present invention. Thus, appearances of the phrases “in one embodiment” or “in an embodiment” in various places throughout this specification are not necessarily all referring to the same embodiment.

Furthermore, the described features, structures, or characteristics may be combined in any suitable manner in one or more embodiments. One skilled in the relevant art will recognize, however, that the invention can be practiced without one or more of the specific details, or with other methods, components, etc. In other instances, well-known structures, or operations are not shown or described in detail to avoid obscuring aspects of the invention. The illustrated embodiments of the invention will be best understood by reference to the drawings, wherein like parts are designated by like numerals throughout. The following description is intended only by way of example, and simply illustrates certain selected embodiments of apparatus and methods that are consistent with the invention as claimed herein.

In order to improve the prediction accuracy or coding performance of cross-component prediction, various schemes related to inheriting cross-component models are disclosed.

In the present invention, new methods related to fusion of multiple intra prediction signals are disclosed. In ECM-8.0, the predictor for the primary intra prediction mode is generated using a single reference line indicated by the specified reference index n0. The predictor for the second intra prediction mode is generated using a single reference line indexed by (n0+1). That is, Eq. (1) can be re-written as follows:

$${P}_{fusion} = {w}_{0} * {P}_{m 0 , n 0} + {w}_{1} * {P}_{m 1 , n 0 + 1} \qquad ( 2 )$$

where P_{m,n} is an intra prediction signal derived by the reconstructed samples from the reference line indexed by n using an intra prediction mode m.

According to one aspect of the present invention, when a fusion of more than one selected intra prediction mode is used to generate an intra prediction signal for predicting a current block, the predictor corresponding to one selected intra prediction mode can be further generated by multi-line fusion, wherein the prediction signal corresponding to one selected intra prediction mode is a weighted sum of prediction signals resulted from different reference lines using the selected intra mode. In the proposed method, a video coder may generate a multi-mode fused intra prediction signal Passion for predicting a current block by a weighted sum of multiple intra prediction signals corresponding to different intra prediction modes, given by

$${P}_{fusion} = {\sum }_{i}^{} {w}_{i} * {P}_{mi}$$

where wᵢ is a fusion weight for a intra prediction signal Pₘᵢ corresponding to a selected intra mode mi. The video coder may further comprise generating an intra prediction signal Pₘᵢ corresponding to a selected intra mode mi by multi-line fusion, given by

$${P}_{mi} = {\sum }_{j}^{} {c}_{i , j} * {P}_{mi , nj}$$

where c_{i,j} is a fusion weight for an intra prediction signal P_{mi,nj} derived by the reconstructed samples from a reference line indexed by n/using the selected intra mode mi.

In one embodiment, the intra prediction signal for predicting a current block is a multi-mode fusion of the intra predictors Pₘ₀ and Pₘ₁ corresponding to intra prediction modes m0 and m1, respectively. Pₘ₀ and Pₘ₁ are respectively generated by multi-line fusion using two reference lines, as follows:

$${P}_{m 0} = {c}_{0 , 0} * {P}_{m 0 , n 0} + {c}_{0 , 1} * {P}_{m 0 , n 0 + 1} ,$$

$${P}_{m 1} = {c}_{1 , 0} * {P}_{m 1 , n 0} + {c}_{1 , 1} * {P}_{m 1 , n 0 + 1} .$$

wherein c_{0,0}, c_{0,1}, c_{1,0}, and c_{1,1} are fusion weights. In some preferred embodiments, the values of (c_{0,0}, c_{0,1}, c_{1,0}, c_{1,1}) are equal to (1, 0, 0.25, 0.75), (1, 0, 0.5, 0.5), (1, 0, 0.75, 0.25), (0.75, 0.25, 0.25, 0.75), (0.75, 0.25, 0.5, 0.5), (0.75, 0.25, 0.75, 0.25), or (0.75, 0.25, 1, 0). The selected modes m0 and m1 may correspond to the primary intra prediction mode and the second intra prediction mode, respectively, derived by TIMD.

According to one further aspect of the present invention, a video coder may further comprise deriving the set of the weights for multi-line fusion adaptively. In some embodiments, a video coder may derive the set of the fusion weights for intra predicting a current block according to some pre-defined rules. For example, a video coder may implicitly derive the set of the fusion weights for intra predicting a current block dependent on block dimension (width or height), area size, QP, reference line index, or prediction mode associated with the current block. In some preferred embodiments, a video coder may implicitly derive the set of the fusion weights for intra predicting a current block dependent on whether the current block width, height, and/or size is greater or less than one or more specified threshold values.

In some other embodiments, a video coder may signal one or more syntax elements to indicate the values of multi-line fusion weights for intra predicting a current block. For example, a video coder may signal one or more syntax elements to specify the fusion weights in one or more high-level syntax sets such as SPS, PPS, PH, and SH. In some embodiments, a video coder may signal one or more syntax elements in a current block for deriving the selected multi-line fusion weights for intra predicting the current block. For example, an index can be signalled to indicate the selected candidate set of fusion weights from a list of candidate sets of fusion weights. In one embodiment, the list can de pre-defined. For example, the values of (c_{0,0}, c_{0,1}, c_{1,0}, c_{1,1}) may comprise the weight sets listed above or constructed on-the-fly by some specified methods.

The proposed method may further comprise some pre-defined rules for disabling multi-line fusion for deriving the intra prediction signal for a selected intra mode when TIMD fusion mode is used in a current block. In some embodiments, a video coder may disable multi-line fusion for some prediction modes. For example, a video coder may disable multi-line fusion for prediction modes DC, and Planar.

The proposed method may further comprise signalling one or more syntax elements in one or more high-level syntax sets to indicate whether the proposed method is enabled or disable in a current video data unit, wherein the high-level syntax sets may comprise SPS, PPS, PH, SH, or a combination thereof. For example, a video coder may signal a syntax element sps_timd_multimode_multiline_fusion_enable_flag to indicate whether multi-line fusion is enabled for deriving the prediction signal for a selected intra mode when TIMD fusion mode is used in a current block.

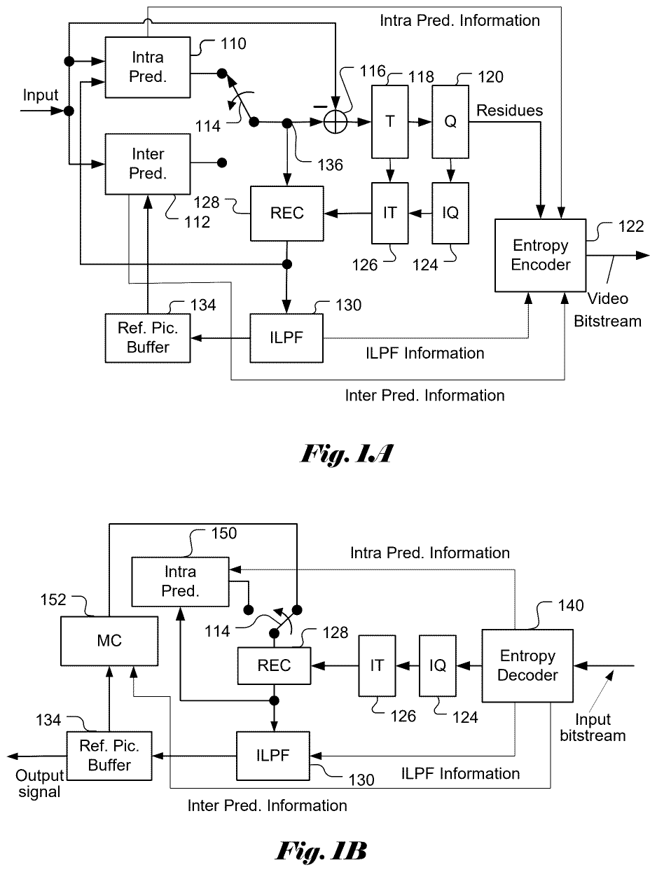

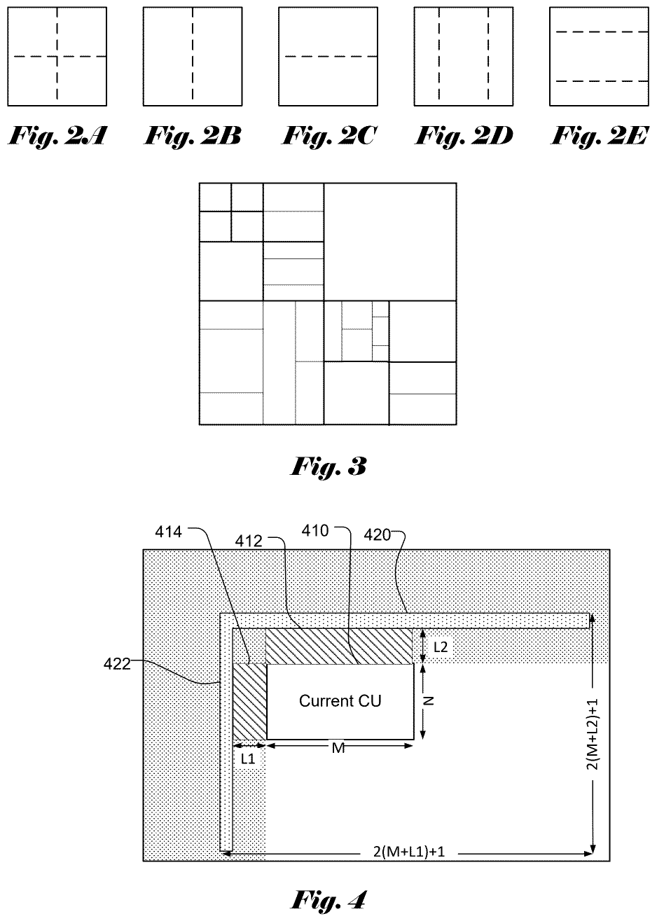

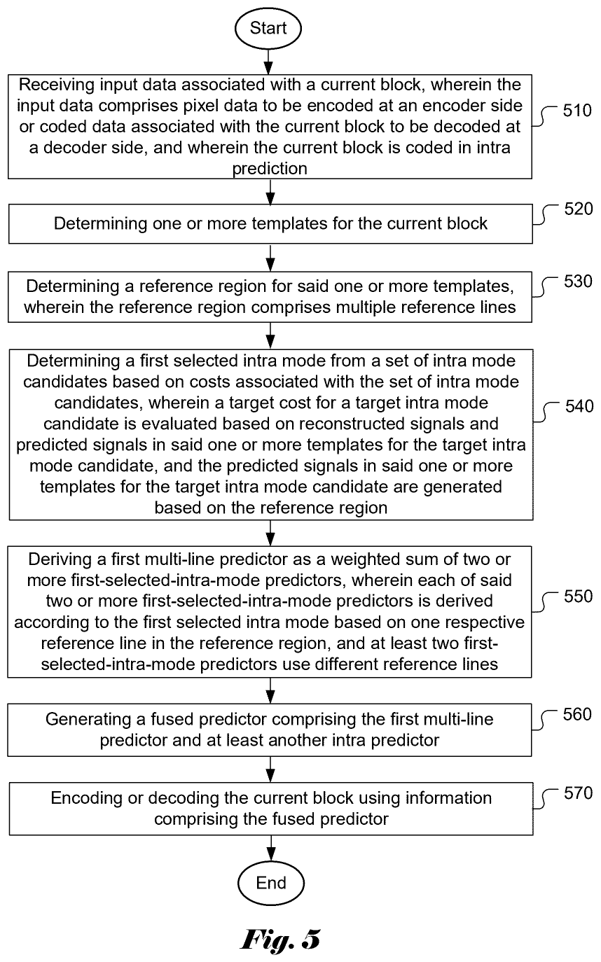

Any of the foregoing proposed fused multi-line predictor methods can be implemented in encoders and/or decoders. For example, any of the proposed methods can be implemented in an intra prediction module of an encoder, and/or an intra prediction module of a decoder. Alternatively, any of the proposed methods can be implemented as circuit integrated to the intra prediction module of the encoder and/or the intra prediction module of the decoder. The proposed aspects, methods and related embodiments can be implemented individually or jointly in an image and video coding system. For example, the fused multi-line predictor as described above can be implemented in an encoder side or a decoder side with reference to FIG. 1A and FIG. 1B. For example, any of the proposed fused multi-line predictor methods can be implemented in an Intra coding module (e.g. Intra Pred. 150 in FIG. 1B) in a decoder or an Intra coding module in an encoder (e.g. Intra Pred. 1102 in FIG. 1A). Any of the proposed candidate derivation method can also be implemented as circuits coupled to the intra coding module at the decoder or the encoder. However, the decoder or encoder may also use additional processing unit to implement the required processing. While the Intra Pred. units (e.g. unit 110 in FIG. 1A and unit 150 in FIG. 1B) are shown as individual processing units, they may correspond to executable software or firmware codes stored on a media, such as hard disk or flash memory, for a CPU (Central Processing Unit) or programmable devices (e.g. DSP (Digital Signal Processor) or FPGA (Field Programmable Gate Array)).

FIG. 5 illustrates a flowchart of an exemplary video coding system that incorporates a multi-line fused predictor according to an embodiment of the present invention. The steps shown in the flowchart may be implemented as program codes executable on one or more processors (e.g., one or more CPUs) at the encoder side. The steps shown in the flowchart may also be implemented based hardware such as one or more electronic devices or processors arranged to perform the steps in the flowchart. According to this method, input data associated with a current block are received in step 510, wherein the input data comprises pixel data to be encoded at an encoder side or coded data associated with the current block to be decoded at a decoder side, and wherein the current block is coded in intra prediction. One or more templates for the current block are determined in step 520. A reference region for said one or more templates is determined in step 530, wherein the reference region comprises multiple reference lines. A first selected intra mode from a set of intra mode candidates is determined based on costs associated with the set of intra mode candidates in step 540, wherein a target cost for a target intra mode candidate is evaluated based on reconstructed signals and predicted signals in said one or more templates for the target intra mode candidate, and the predicted signals in said one or more templates for the target intra mode candidate are generated based on the reference region. A first multi-line predictor is derived as a weighted sum of two or more first-selected-intra-mode predictors in step 550, wherein each of said two or more first-selected-intra-mode predictors is derived according to the first selected intra mode based on one respective reference line in the reference region, and at least two first-selected-intra-mode predictors use different reference lines. A fused predictor comprising the first multi-line predictor and at least another intra predictor is generated in step 560. The current block is encoded or decoded using information comprising the fused predictor in step 570.

The flowchart shown is intended to illustrate an example of video coding according to the present invention. A person skilled in the art may modify each step, re-arranges the steps, split a step, or combine steps to practice the present invention without departing from the spirit of the present invention. In the disclosure, specific syntax and semantics have been used to illustrate examples to implement embodiments of the present invention. A skilled person may practice the present invention by substituting the syntax and semantics with equivalent syntax and semantics without departing from the spirit of the present invention.

The above description is presented to enable a person of ordinary skill in the art to practice the present invention as provided in the context of a particular application and its requirement. Various modifications to the described embodiments will be apparent to those with skill in the art, and the general principles defined herein may be applied to other embodiments. Therefore, the present invention is not intended to be limited to the particular embodiments shown and described, but is to be accorded the widest scope consistent with the principles and novel features herein disclosed. In the above detailed description, various specific details are illustrated in order to provide a thorough understanding of the present invention. Nevertheless, it will be understood by those skilled in the art that the present invention may be practiced.

Embodiment of the present invention as described above may be implemented in various hardware, software codes, or a combination of both. For example, an embodiment of the present invention can be one or more circuit circuits integrated into a video compression chip or program code integrated into video compression software to perform the processing described herein. An embodiment of the present invention may also be program code to be executed on a Digital Signal Processor (DSP) to perform the processing described herein. The invention may also involve a number of functions to be performed by a computer processor, a digital signal processor, a microprocessor, or field programmable gate array (FPGA). These processors can be configured to perform particular tasks according to the invention, by executing machine-readable software code or firmware code that defines the particular methods embodied by the invention. The software code or firmware code may be developed in different programming languages and different formats or styles. The software code may also be compiled for different target platforms. However, different code formats, styles and languages of software codes and other means of configuring code to perform the tasks in accordance with the invention will not depart from the spirit and scope of the invention.

The invention may be embodied in other specific forms without departing from its spirit or essential characteristics. The described examples are to be considered in all respects only as illustrative and not restrictive. The scope of the invention is therefore, indicated by the appended claims rather than by the foregoing description. All changes which come within the meaning and range of equivalency of the claims are to be embraced within their scope.

1. A method of video coding, the method comprising:
receiving input data associated with a current block, wherein the input data comprises pixel data to be encoded at an encoder side or coded data associated with the current block to be decoded at a decoder side, and wherein the current block is coded in intra prediction;
determining one or more templates for the current block;
determining a reference region for said one or more templates, wherein the reference region comprises multiple reference lines;
determining a first selected intra mode from a set of intra mode candidates based on costs associated with the set of intra mode candidates, wherein a target cost for a target intra mode candidate is evaluated based on reconstructed signals and predicted signals in said one or more templates for the target intra mode candidate, and the predicted signals in said one or more templates for the target intra mode candidate are generated based on the reference region;
deriving a first multi-line predictor as a weighted sum of two or more first-selected-intra-mode predictors, wherein each of said two or more first-selected-intra-mode predictors is derived according to the first selected intra mode based on one respective reference line in the reference region, and at least two first-selected-intra-mode predictors use different reference lines;
generating a fused predictor comprising the first multi-line predictor and at least another intra predictor; and
encoding or decoding the current block using information comprising the fused predictor.

2. The method of claim 1, wherein said at least another intra predictor comprises a second multi-line predictor generated by determining a second selected intra mode from the set of intra mode candidates based on the costs associated with the set of intra mode candidates, and deriving the second multi-line predictor as a weighted sum of two or more second-selected-intra-mode predictors, wherein each of said two or more second-selected-intra-mode predictors is derived according to the second selected intra mode based on one respective reference line in the reference region, and at least two second-selected-intra-mode predictors use different reference lines.

3. The method of claim 1, wherein a set of weights for the weighted sum of two or more first-selected-intra-mode predictors is determined for the current block adaptively.

4. The method of claim 1, wherein a set of weights for the weighted sum of two or more first-selected-intra-mode predictors is determined for the current block according to one or more pre-defined rules.

5. The method of claim 1, wherein one or more syntax elements to indicate values of a set of weights for the weighted sum of two or more first-selected-intra-mode predictors are signalled in a bitstream or parsed from the bitstream.

6. The method of claim 5, wherein said one or more syntax elements are in one or more high-level syntax sets.

7. The method of claim 5, wherein said one or more syntax sets comprise SPS (Sequence Parameter Set), PPS (Picture Parameter Set), PH (Picture Header), SH (Slice Header), or a combination thereof.

8. The method of claim 1, wherein one or more syntax elements are signalled in a bitstream or parsed from the bitstream for deriving values of a set of weights for the weighted sum of two or more first-selected-intra-mode predictors.

9. The method of claim 1, wherein said deriving the first multi-line predictor and said generating the fused predictor comprising the first multi-line predictor and said at least another intra predictor are disabled for the current block according to one or more pre-defined rules.

10. The method of claim 1, wherein said deriving the first multi-line predictor and said generating the fused predictor comprising the first multi-line predictor and said at least another intra predictor are disabled for the current block if the current block is coded in one or more target prediction modes.

11. The method of claim 10, wherein said one or more target prediction modes comprise DC prediction mode and Planar prediction mode.

12. The method of claim 1, wherein one or more high-level syntax sets are used to indicate whether said deriving the first multi-line predictor and said generating the fused predictor comprising the first multi-line predictor and said at least another intra predictor are enabled or disabled for a current video data unit.

13. The method of claim 12, wherein said one or more high-level syntax sets comprise SPS (Sequence Parameter Set), PPS (Picture Parameter Set), PH (Picture Header), SH (Slice Header), or a combination thereof.

14. The method of claim 1, wherein a set of weights for the weighted sum of two or more first-selected-intra-mode predictors is determined implicitly.

15. The method of claim 14, wherein the set of weights for the weighted sum of two or more first-selected-intra-mode predictors is determined according to block dimension, area size, QP, reference line index, prediction mode associated with the current block, or a combination thereof.

16. The method of claim 1, wherein a set of weights for the weighted sum of two or more first-selected-intra-mode predictors is determined implicitly when width, height, and/or size of the current block is greater than or less than one or more specified threshold values.

17. An apparatus of video coding, the apparatus comprising one or more electronics or processors arranged to:
receive input data associated with a current block, wherein the input data comprises pixel data to be encoded at an encoder side or coded data associated with the current block to be decoded at a decoder side, and wherein the current block is coded in intra prediction;
determine one or more templates for the current block;
determine a reference region for said one or more templates, wherein the reference region comprises multiple reference lines;
determine a first selected intra mode from a set of intra mode candidates based on costs associated with the set of intra mode candidates, wherein a target cost for a target intra mode candidate is evaluated based on reconstructed signals and predicted signals in said one or more templates for the target intra mode candidate, and the predicted signals in said one or more templates for the target intra mode candidate are generated based on the reference region;
derive a first multi-line predictor as a weighted sum of two or more first-selected-intra-mode predictors, wherein each of said two or more first-selected-intra-mode predictors is derived according to the first selected intra mode based on one respective reference line in the reference region, and at least two first-selected-intra-mode predictors use different reference lines;
generate a fuse predictor comprising the first multi-line predictor and at least another intra predictor; and
encode or decode the current block using information comprising the fused predictor.
